(19) United States
(12) Patent Application Publication
(10) Pub. No.: US 2022/0126879 A1
(43) Pub. Date: Apr. 28, 2022

(54) AUTONOMOUS DRIVING SYSTEM

(71) Applicant: Mitsubishi Electric Corporation, Tokyo (JP)

(72) Inventors: Yuji IGARASHI, Tokyo (JP); Kengo YOKOYAMA, Tokyo (JP)

(73) Assignee: Mitsubishi Electric Corporation, Tokyo (JP)

(21) Appl. No.: 17/427,953

(22) PCT Filed: May 30, 2019
(86) PCT No.: PCT/JP2019/021483

§ 371 Date: Aug. 3, 2021

(51) Int. Cl. B60W 60/00; B60W 40/12; G07C 5/00

(52) U.S. Cl. CPC B60W 60/0059; B60W 60/001; G07C 5/008; B60W 40/12; B60W 60/0051

(57) ABSTRACT

The present disclosure includes: an autonomous driving function selection device through which selection as to necessity of autonomous driving is performed; an on-vehicle wireless communication device which outputs device status information; an authentication information input/output device which outputs authentication information usability information; an on-vehicle control device which outputs, based on the outputs from the on-vehicle wireless communication device and the authentication information input/output device, usability status information and usability information about the on-vehicle wireless communication device and the authentication information input/output device; an information providing device which physically reports, inside a vehicle, a status regarding usability based on the usability status information; and an autonomous traveling control device which performs determination as to possibility of execution of autonomous driving based on the usability information and information, about necessity of autonomous driving, selected through the autonomous driving function selection device.

### TECHNICAL FIELD

The present disclosure relates to an autonomous driving system.

### BACKGROUND ART

Technological development has been progressing in recent years such that autonomous driving vehicles that have an autonomous driving function and that execute autonomous driving are put into practical use.

In the case where such an autonomous driving vehicle has been put into practical use, it is desirable that coexistence of the autonomous driving vehicle and a non-autonomous driving vehicle which is a vehicle other than an autonomous driving vehicle is avoided on a road on which the autonomous driving vehicle travels. Considering this, studies have been conducted regarding infrastructure development that involves: setting of autonomous-driving-vehicle-dedicated roads on which only autonomous driving vehicles travel; and establishment of driving mode transition areas in each of which a driver is guided, before execution of autonomous driving, to select whether to turn on (enable) or turn off (disable) an autonomous driving function of the autonomous driving vehicle (see, for example, Patent Document 1).

### CITATION LIST

### Patent Document

Patent Document 1: Japanese Laid-Open Patent Publication No. 2002-163756

### SUMMARY OF THE INVENTION

### Problems to be Solved by the Invention

In the above Patent Document 1, coexistence of the autonomous driving vehicle and a non-autonomous driving vehicle can be avoided. Meanwhile, if the autonomous-driving-vehicle-dedicated roads include a toll road, since it is difficult to make a payment in cash at a toll gate on a toll road during execution of autonomous driving, the autonomous driving vehicle needs to travel on a route on which automatic toll collection such as ETC can be performed. However, a driving mode transition area is set at, for example, a branch-off place before a gate for entry to such an autonomous-driving-vehicle-dedicated road, and thus it is difficult to set a sufficient section. Therefore, the following problem arises. That is, when the driver is requested to select, within the short section, a traveling route and whether or not to use autonomous driving, the driver sometimes cannot turn on the autonomous driving function within the driving mode transition area even if the driver wishes to turn on the autonomous driving function.

In addition, the following problem also arises. That is, there is a case where, when the autonomous driving vehicle enters the driving mode transition area, on-vehicle equipment necessary for traveling on the autonomous-driving-vehicle-dedicated road does not satisfy a requirement (for example, an ETC on-vehicle device is not mounted, an ETC on-vehicle device is not powered on, an ETC card has not yet been inserted, or an ETC card is unusable because, for example, the term of validity thereof has expired). Such a case results in a situation in which the autonomous driving function cannot be turned on regardless of the intention of the driver.

The present disclosure has been made to solve the aforementioned problems, and an object of the present disclosure is to obtain an autonomous driving system that assuredly executes autonomous driving when autonomous driving is possible.

### Solution to the Problems

An autonomous driving system according to the present disclosure includes: an autonomous driving function selection device through which selection as to necessity of autonomous driving is performed; an on-vehicle wireless communication device which outputs device status information indicating an operational status of the on-vehicle wireless communication device itself; an authentication information input/output device which outputs usability information about authentication information for use during driving; an on-vehicle control device which outputs, on the basis of the outputs from the on-vehicle wireless communication device and the authentication information input/output device, usability status information about the on-vehicle wireless communication device and the authentication information input/output device and usability information about the on-vehicle wireless communication device and the authentication information input/output device; an information providing device which physically reports, inside a vehicle, a status regarding usability on the basis of the usability status information; and an autonomous traveling control device which performs determination as to possibility of execution of autonomous driving on the basis of the usability information and information that is about necessity of autonomous driving and that has been selected through the autonomous driving function selection device.

### Effect of the Invention

The autonomous driving system according to the present disclosure makes it possible to assuredly execute autonomous driving when autonomous driving is possible.

### BRIEF DESCRIPTION OF THE DRAWINGS

FIG. 1 is a diagram showing the entire configuration of an autonomous driving system according to embodiment 1.

FIG. 2 is a flowchart showing processes that are performed at the time of start-up of the autonomous driving system according to embodiment 1.

FIG. 3 is a flowchart showing processes that are performed by the autonomous driving system according to embodiment 1 at the time of information reception.

FIG. 4 is a configuration diagram showing an example of hardware of an on-vehicle control device.

FIG. 5 is a diagram showing the entire configuration of an autonomous driving system according to embodiment 2.

FIG. 6 is a flowchart showing processes that are performed at the time of start-up of the autonomous driving system according to embodiment 2.

FIG. 7 is a diagram showing the entire configuration of an autonomous driving system according to embodiment 3.

FIG. 8 is a diagram showing an implementation example of supervisory sequence information in the autonomous driving system according to embodiment 3.

FIG. 9 is a flowchart showing processes that are performed by an in-vehicle communication gateway device included in the autonomous driving system according to embodiment 3.

### DESCRIPTION OF EMBODIMENTS

Hereinafter, autonomous driving systems according to embodiments of the present disclosure will be described with reference to the drawings. Description will be given while the same or corresponding members and portions in the drawings are denoted by the same reference characters.

### Embodiment 1

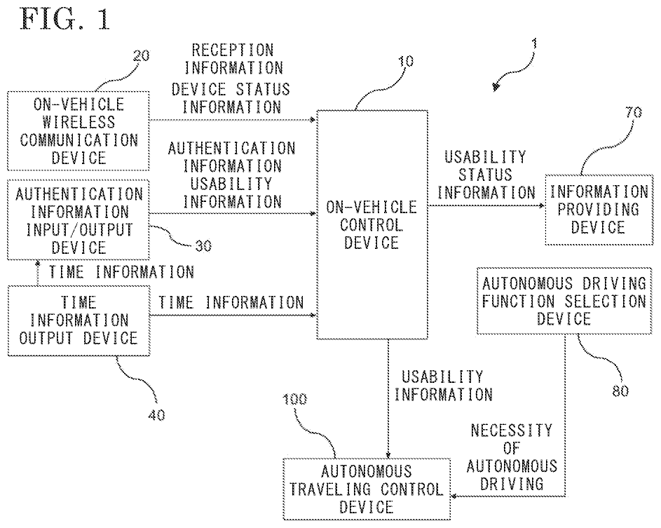

FIG. 1 is a diagram showing the entire configuration of an autonomous driving system 1 according to embodiment 1. The autonomous driving system 1 is a system included in an autonomous driving vehicle (not shown) that executes autonomous driving. The autonomous driving system 1 includes an on-vehicle control device 10, an on-vehicle wireless communication device 20, an authentication information input/output device 30, a time information output device 40, an information providing device 70, an autonomous driving function selection device 80, and an autonomous traveling control device 100. The on-vehicle wireless communication device 20 and the authentication information input/output device 30 are included in an apparatus that provides: information necessary for autonomous driving and obtained through communication with the outside of the autonomous driving vehicle; and/or information necessary for autonomous driving and physically reported inside the vehicle. The on-vehicle wireless communication device 20 and the authentication information input/output device 30 are connected to the on-vehicle control device 10. In the autonomous driving system 1, the on-vehicle control device 10 outputs, on the basis of outputs from the on-vehicle wireless communication device 20 and the authentication information input/output device 30, usability status information about the on-vehicle wireless communication device 20 and the authentication information input/output device 30 and usability information about the on-vehicle wireless communication device 20 and the authentication information input/output device 30, and the autonomous traveling control device 100 performs determination as to possibility of execution of autonomous driving. The details of each device included in the autonomous driving system 1 will be described below.

The autonomous traveling control device 100 is a device that executes each of functions (creation of a traveling trajectory, and control of a motor, an engine, steering, a brake, and the like according to the created traveling trajectory) for autonomous driving by the autonomous driving vehicle, and performs determination as to possibility of execution of autonomous driving on the basis of the usability information and information that is about necessity of autonomous driving and that has been selected through the autonomous driving function selection device 80. The autonomous traveling control device 100 has three modes, i.e., an “enabled mode”, a “disabled mode”, and an “emergency stop mode”, regarding execution of autonomous driving. Only if the information that is about necessity of autonomous driving and that has been selected through the autonomous driving function selection device 80 indicates “necessary” and “usable” is inputted as the usability information from the on-vehicle control device 10 to the autonomous traveling control device 100, the autonomous traveling control device 100 determines that the autonomous driving is possible, and the mode of the autonomous traveling control device 100 is set to the “enabled mode” so that autonomous driving is executed. Immediately after start-up of the autonomous driving system 1, the mode of the autonomous traveling control device 100 is the “disabled mode”. If the usability information about the apparatus is set to “unusable” at a timing regarded as the timing of an abnormal sequence, the mode of the autonomous traveling control device 100 is set to the “emergency stop mode” according to design of the autonomous driving system 1. A condition for the “emergency stop mode” is, for example, a case where: the mode, for autonomous driving, of the autonomous traveling control device 100 is the “enabled mode”; and, during execution of autonomous driving (while the autonomous driving function of the autonomous traveling control device 100 is ON), “unusable” is reported as the usability information about the apparatus from the on-vehicle control device 10 to the autonomous traveling control device 100.

The on-vehicle wireless communication device 20 outputs, to the on-vehicle control device 10, wirelessly received reception information and device status information indicating an operational status (“normal” or “abnormal”) of the on-vehicle wireless communication device 20 itself. The on-vehicle wireless communication device 20 is a wireless communication device capable of: communication using frequencies in the 5.8 GHz band used in electronic toll collection (ETC) systems and the like and the 5.9 GHz band used in 802.11p; short-range wireless communication called dedicated short-range communication (DSRC) using near-infrared radiation or the like; or long-range wireless communication over 3G, LTE, and the like. In the present embodiment, either short-range communication or long-range communication can be used, but, for easy understanding of the details of the present embodiment, an example will be described in which communication of the on-vehicle wireless communication device for ETC, i.e., short-range wireless communication in the 5.8 Ghz band (5.8-Ghz-band DSRC), is used. It is noted that the 5.8-Ghz-band DSRC can cause, between a road-side wireless device installed outside the vehicle and the on-vehicle wireless communication device 20 (between the road and the vehicle), 1:1 individual communication between the road-side wireless communication device and the on-vehicle wireless communication device 20 and 1:N broadcast communication (delivery of the same information from the road-side wireless communication device to a plurality of on-vehicle wireless communication devices). A communication coverage area (area in which communication can be performed) for the 5.8-Ghz-band DSRC is about 20 to 50 meters in the individual communication and is about 70 to 150 meters in the broadcast communication.

The reception information is outputted when the information is received. Examples of the reception information include: ETC toll gate pre-notice information indicating that an ETC toll gate is present in front of the autonomous driving vehicle; ETC entrance passage information indicating that the autonomous driving vehicle has passed through the entrance of an ETC toll gate; ETC exit passage information indicating that the autonomous driving vehicle has passed through the exit of an ETC toll gate; and autonomous driving start inquiry information for making an inquiry as to whether or not to start autonomous driving regardless of presence/absence of an ETC toll gate. The device status information is outputted if communication between the on-vehicle wireless communication device 20 and the on-vehicle control device 10 is established. Alternatively, the device status information is outputted if the status of the on-vehicle wireless communication device 20 is changed (when content of the device status information is updated). Alternatively, the device status information is repetitively outputted at a constant cycle.

The authentication information input/output device 30 outputs, to the on-vehicle control device 10, usability information (“usable” or “unusable”) about authentication information for use during driving. The authentication information input/output device 30 is a device that authenticates a user of the authentication information input/output device 30 and that reads an ID used for bill payment. The authentication information input/output device 30 is implemented by: an ETC card reader; a reader for an RF-ID used for electronic money; or the like. In the present embodiment, an example in which an ETC card reader is used will be described for easy understanding of the details of the present embodiment. The ETC card reader is integrated with the on-vehicle wireless communication device 20, reads an ETC card at the time of start-up of the on-vehicle wireless communication device 20 or at the time of insertion of the ETC card, and outputs usability information indicating whether or not the ETC card is usable. It is noted that the authentication information input/output device 30 needs to check, for example, the term of validity (for example, the term of validity is until Mar. 31, 2019) of the ETC card inserted into the authentication information input/output device 30, to perform a process of determining whether or not the ETC card is usable. Thus, time information is inputted from the time information output device 40 to the authentication information input/output device 30.

The time information output device 40 outputs the time information to the authentication information input/output device 30 and the on-vehicle control device 10. The time information output device 40 may realize the time information by a real time clock (RTC) or may use time information received from the global positioning system (GPS).

If the device status information outputted from the on-vehicle wireless communication device 20 indicates “normal” and the authentication information usability information outputted from the authentication information input/output device 30 indicates “usable”, the on-vehicle control device 10 sets the usability status information as “usable” and outputs the usability status information to the information providing device 70, and sets the usability information as “usable” and outputs the usability information to the autonomous traveling control device 100. If the outputted result is a combination other than the combination of “normal” and “usable”, the on-vehicle control device 10 sets the usability status information as “unusable” and outputs the usability status information to the information providing device 70, and sets the usability information as “unusable” and outputs the usability information to the autonomous traveling control device 100.

The information providing device 70 is a device that physically reports, inside the vehicle, a status regarding usability on the basis of the usability status information outputted from the on-vehicle control device 10. Specifically, the information providing device 70 reports the status to the driver of the autonomous driving vehicle by means of voice or display. It is noted that the information providing device 70 not only reports the usability status information to the driver but also may add, to the usability status information, information indicating a reason regarding possibility (for example, the device status information indicates “normal”, and the usability information from the authentication device indicates that “an ETC card has not yet been inserted”), to report the specific reason, i.e., report that “the autonomous driving function cannot be used because an ETC card has not yet been inserted”, to the driver by means of voice or display.

The autonomous driving function selection device 80 is a device through which selection as to necessity of autonomous driving is performed by an operation of the driver and that outputs the result of the selection to the autonomous traveling control device 100, to instruct the autonomous traveling control device 100 to execute autonomous driving. Specifically, the autonomous driving function selection device 80 is implemented by a means such as a push-button-type or slide-type mechanical switch, an electronic switch on a touch panel or the like, or voice recognition. The signal outputted to the autonomous traveling control device 100 does not pass via the on-vehicle control device 10 but is directly inputted to the autonomous traveling control device 100 for the purpose of guaranteeing the reliability of functions.

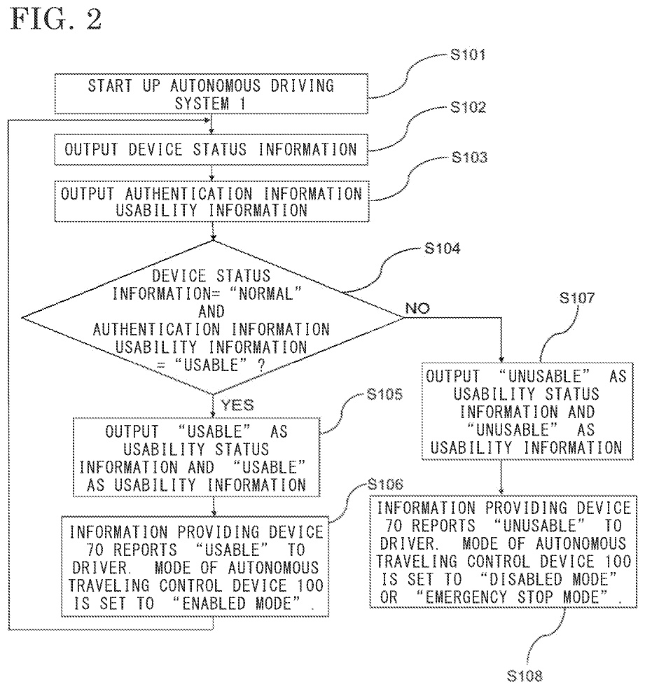

Next, processes that are performed at the time of start-up of the autonomous driving system 1 will be described. FIG. 2 is a flowchart showing processes that are performed at the time of start-up of the autonomous driving system 1 according to embodiment 1. First, the autonomous driving system 1 is started up (step S101). The time of start-up of the autonomous driving system 1 refers to a time at which each device composing the autonomous driving system 1 has been powered on and has become usable. The time is, for example, the time of start of the autonomous driving vehicle or the time at which the driver intentionally starts up the autonomous driving system 1.

After the start-up, the on-vehicle wireless communication device 20 outputs, to the on-vehicle control device 10, device status information indicating an operational status (“normal” or “abnormal”) of the on-vehicle wireless communication device 20 itself (step S102). In addition, the authentication information input/output device 30 outputs, to the on-vehicle control device 10, authentication information usability information (“usable” or “unusable”) indicating whether or not authentication information is usable (step S103).

The on-vehicle control device 10 determines whether: the device status information outputted from the on-vehicle wireless communication device 20 indicates “normal” or not; and the authentication information usability information outputted from the authentication information input/output device 30 indicates “usable” or not (step S104). If the result of the determination is the combination of “normal” and “usable”, the procedure proceeds to step S105. Meanwhile, if the result is a combination other than the combination of “normal” and “usable”, the procedure proceeds to step S107.

In the case of the combination of “normal” and “usable”, the on-vehicle control device 10 sets the usability status information as “usable” and outputs the usability status information to the information providing device 70, and sets the usability information as “usable” and outputs the usability information to the autonomous traveling control device 100 (step S105). The information providing device 70 reports, to the driver, that autonomous driving is in a “usable” status by means of voice or display. If the driver gives an instruction to execute autonomous driving through the autonomous driving function selection device 80, the autonomous traveling control device 100 performs determination as to possibility of execution of autonomous driving, and the mode of the autonomous traveling control device 100 is set to the “enabled mode” so that autonomous driving is executed (step S106).

In the case of a combination other than the combination of “normal” and “usable”, the on-vehicle control device 10 sets the usability status information as “unusable” and outputs the usability status information to the information providing device 70, and sets the usability information as “unusable” and outputs the usability information to the autonomous traveling control device 100 (step S107). The information providing device 70 reports, to the driver, that the autonomous driving function is in an “unusable” status, by means of voice or display. The autonomous traveling control device 100 performs determination as to possibility of execution of autonomous driving, and the mode of the autonomous traveling control device 100 is set to the “disabled mode” or the “emergency stop mode” so that the autonomous driving function is in an unusable status even if the driver gives an instruction to execute autonomous driving through the autonomous driving function selection device 80 (step S108).

Regarding the description of the processes that are performed by the autonomous driving system 1 when the autonomous driving system 1 is started up, the output of the usability status information about autonomous driving to the information providing device 70 by the on-vehicle control device 10 and the output of the usability information to the autonomous traveling control device 100 by the on-vehicle control device 10 are performed at the time of start-up of the autonomous driving system 1 and at a predetermined cycle in order to assuredly continue to operate the autonomous driving system 1. The cycle is, for example, 100 milliseconds or several seconds. A specific method of implementation is any of: a request-response type communication method in which a request for an input of the usability information is made from the autonomous traveling control device 100 to the on-vehicle control device 10 at an arbitrarily-selected cycle so that the input is acquired; a push-type communication method in which the on-vehicle control device 10 outputs the usability information from the on-vehicle control device 10 to the autonomous traveling control device 100 at a constant cycle or at the time of occurrence of an event such as insertion of an ETC card; or a communication method in which the request-response type and push-type communication methods are used in combination.

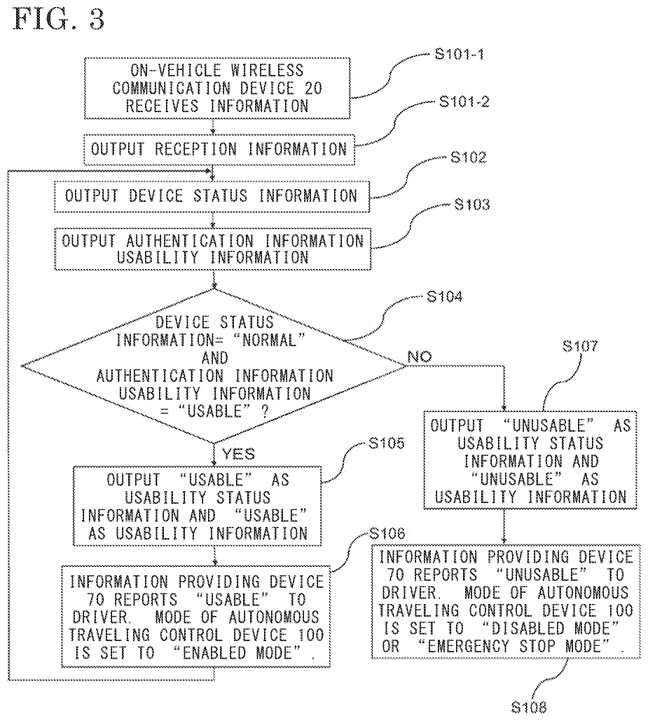

Next, processes that are performed by the autonomous driving system 1 when the on-vehicle wireless communication device 20 receives information will be described. FIG. 3 is a flowchart showing processes that are performed by the autonomous driving system 1 according to embodiment 1 at the time of information reception. First, the on-vehicle wireless communication device 20 receives information (step S101-1). The on-vehicle wireless communication device 20 outputs the received information to the on-vehicle control device 10 (step S101-2). Processes in step S102 after the output and the subsequent steps, are the same as those described with reference to FIG. 2, and thus descriptions thereof will be omitted.

In the case where the received information is ETC toll gate pre-notice information indicating that an ETC toll gate is present in front of the autonomous driving vehicle, the on-vehicle wireless communication device 20 outputs the ETC toll gate pre-notice information to the on-vehicle control device 10. If an ETC toll gate is present in front, the driver can assuredly perform check as to usability of the autonomous driving function. Thus, even when an ETC card has not yet been inserted, the driver can take a necessary action with plenty of time.

Meanwhile, in the case where the received information is ETC entrance passage information indicating that the autonomous driving vehicle has passed through the entrance of an ETC toll gate, the on-vehicle wireless communication device 20 outputs the ETC entrance passage information to the on-vehicle control device 10. In this case, the driver can perform check as to usability of the autonomous driving function after the autonomous driving vehicle has passed through the entrance of an ETC toll gate. Thus, for example, a restriction that the autonomous driving function is usable only in a specific section such as an expressway on which use of autonomous driving is permitted, can be imposed on the autonomous driving vehicle. At this time, in step S102, “normal” is outputted as the device status information about the on-vehicle wireless communication device 20 to the on-vehicle control device 10. It is noted that a toll gate ID indicating a toll gate is present also at the ETC toll gate. Thus, an operation only after the autonomous driving vehicle has passed through the entrance of a toll gate provided in a specific section in which autonomous driving is possible, is also sufficient. A list of IDs of toll gates at which the autonomous driving function is usable may be stored in advance in a storage device or the like provided to the on-vehicle control device 10. Alternatively, the list may be received from the on-vehicle wireless communication device 20, to be stored in the storage device.

Meanwhile, in the case where the received information is ETC exit passage information indicating that the autonomous driving vehicle has passed through the exit of an ETC toll gate, the on-vehicle wireless communication device 20 outputs the ETC exit passage information to the on-vehicle control device 10. In this case, contrary to the case after the passage through the ETC entrance, the autonomous driving function is unusable because the autonomous driving vehicle has passed through the exit of a specific ETC toll gate prior to which autonomous driving is possible. At this time, in step S102, “disabled” is outputted as the device status information about the on-vehicle wireless communication device 20 to the on-vehicle control device 10. For distinguishment from “abnormal” indicating a failure of the on-vehicle wireless communication device 20, this “disabled” indicates, apart from a failure of the on-vehicle wireless communication device 20, that the on-vehicle wireless communication device 20 is in a state of not functioning with respect to the autonomous driving system 1.

Meanwhile, in the case where the received information is autonomous driving start inquiry information for making an inquiry as to whether or not to start autonomous driving regardless of presence/absence of an ETC toll gate, the on-vehicle wireless communication device 20 outputs the autonomous driving start inquiry information to the on-vehicle control device 10. If an autonomous driving administrative server which is an inquiry source of the autonomous driving start inquiry information is verified to be reliable, “normal” is outputted as the device status information about the on-vehicle wireless communication device 20 to the on-vehicle control device 10 in step S102. The verification of reliability is performed according to, for example, the following procedure. The on-vehicle wireless communication device 20 receives a certificate (certification authority (CA)) indicating an inquiry source by using transport layer security (TLS) communication, and checks whether or not content (the name of the autonomous driving administrative server, an organization name, a department name, a city/ward/town/village name, a prefecture name, and a country code), a public key, an issuance office name, an electronic signature, the term of validity, and a version/number/encryption scheme of the certificate CA matches those of a certificate CA registered in advance in the on-vehicle wireless communication device 20. Only in the case of matching therebetween, the on-vehicle wireless communication device 20 starts a communication sequence for starting, for autonomous driving, communication with the autonomous driving administrative server which is an inquiry source. This sequence is a communication sequence for starting autonomous driving between the autonomous driving administrative server and the on-vehicle wireless communication device 20. For the on-vehicle wireless communication device 20, constant communication connection with the autonomous driving administrative server is established when this communication sequence is completed.

After the establishment of the connection, the on-vehicle wireless communication device 20 continues to transmit at least one kind of information to the autonomous driving administrative server at a constant cycle or at a specific timing (at the time of vehicle stoppage, at the time of acceleration/deceleration at a rate equal to or higher than a predetermined value, at the time of a lane change, at the time of a blinker operation, at the time of occurrence of a change in a vehicle-to-vehicle distance by at least a predetermined value). The said information is from among: identification information (a vehicle name and an ID) about the autonomous driving system 1; traveling position information indicating a traveling position (a latitude, a longitude, and an altitude); vehicle behavior information indicating the speed, the acceleration rate, and the yaw rate of the autonomous driving vehicle; an image taken by a camera mounted to the autonomous driving vehicle; or on-vehicle sensor information detected by a sensor such as a LiDAR sensor, an ultrasonic sensor, or a millimeter wave sensor. The on-vehicle wireless communication device 20 receives a response message, to the said information, that has been transmitted from the autonomous driving administrative server. The response message includes autonomous driving continuation possibility information (“possible” or “impossible”) indicating continuation possibility of autonomous driving. If the autonomous driving possibility information indicates “possible”, “normal” is outputted as the device status information about the on-vehicle wireless communication device 20 to the on-vehicle control device 10 in step S102. Meanwhile, if the autonomous driving possibility information indicates “impossible”, “abnormal (communication content is abnormal and autonomous driving is impossible, or an autonomous driving service is invalidated owing to a road condition or the like)” or “invalidated (in autonomous driving ending section or expiration of the term of validity of an autonomous driving service)” is outputted as the device status information about the on-vehicle wireless communication device 20 to the on-vehicle control device 10 in step S102. By doing so, the on-vehicle wireless communication device 20 can set an arbitrarily-selected section as an autonomous-driving-dedicated section regardless of the position of an ETC toll gate. That is, the on-vehicle wireless communication device 20 can set, as an autonomous-driving-dedicated section, also a section in which no ETC road-side radio antenna for reporting start or end of autonomous driving is installed on the road side. It is noted that, in the case where the received information is autonomous driving start inquiry information, the device status information outputted by the on-vehicle wireless communication device 20 includes information that is based on the reception information.

In addition, after the start of autonomous driving, the on-vehicle wireless communication device 20 continues to transmit the said information to the autonomous driving administrative server at the constant cycle or at the specific timing, to receive autonomous driving continuation possibility information from the autonomous driving administrative server. The autonomous driving administrative server can cause autonomous driving of a specific autonomous driving vehicle to be interrupted at an arbitrarily-selected timing. For example, the autonomous driving administrative server may send, to an autonomous driving vehicle on a road on which an accident has occurred, a reply that causes the on-vehicle wireless communication device 20 to output “abnormal (an autonomous driving service is invalid owing to a road condition or the like)” as the device status information. Further, if an autonomous driving service was purchased as a paid subscription service from the autonomous driving administrative server through the autonomous driving system 1 and the term of validity of the purchased autonomous driving service has expired, the autonomous driving administrative server may cause “invalidated (expiration of the term of validity of the autonomous driving service)” to be outputted as the device status information and may cause the information providing device 70 to report “availability of an additionally purchasable autonomous driving service” to the driver so that the driver can perform selection.

It is noted that possibility determination for the usability information to be outputted to the autonomous traveling control device 100 is changed according to an apparatus configuration. For example, device status information indicating whether or not the time information output device 40 or the information providing device 70 is normally operating may be inputted to the on-vehicle control device 10 in the same manner as the output of the device status information about the on-vehicle wireless communication device 20 itself from the on-vehicle wireless communication device 20 to the on-vehicle control device 10, and, in a state where three devices which are the on-vehicle wireless communication device 20, the time information output device 40, and the information providing device 70 are normally operating and the authentication information usability information indicates “the ETC card is usable”, the on-vehicle control device 10 may set the usability information as “usable” and output the usability information to the autonomous traveling control device 100.

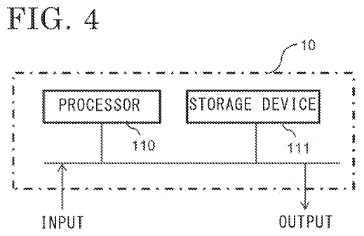

As shown in FIG. 4, an example of hardware of each of the on-vehicle control device 10 and the autonomous traveling control device 100 is composed of a processor 110 and a storage device 111. The storage device 111 including programs to be executed by the on-vehicle control device 10 and the autonomous traveling control device 100 includes, for example, a volatile storage device such as a random access memory and a nonvolatile auxiliary storage device such as a flash memory. Alternatively, the storage device 111 may include, as the auxiliary storage device, a hard disk instead of a flash memory. The processor 110 executes a program inputted from the storage device 111 so that the on-vehicle control device 10 outputs the usability status information to the information providing device 70 and outputs the usability information to the autonomous traveling control device 100. The autonomous traveling control device 100 performs determination as to possibility of execution of autonomous driving. In this case, the program is inputted from the auxiliary storage device via the volatile storage device to the processor 110. In addition, the processor 110 may output data such as a calculation result to the volatile storage device of the storage device 111 or save the data via the volatile storage device to the auxiliary storage device.

As described above, in the autonomous driving system 1 according to embodiment 1, the on-vehicle control device 10 outputs, on the basis of the outputs from the on-vehicle wireless communication device 20 and the authentication information input/output device 30, the usability status information to the information providing device 70 and the usability information to the autonomous traveling control device 100. Thus, a report that use of ETC cannot be started and autonomous driving cannot be executed, can be made to the driver and the autonomous traveling control device 100 at the time of start-up of the autonomous driving system 1. Therefore, the driver can be prompted to insert an ETC card into the authentication information input/output device 30 in advance. Consequently, autonomous driving can be assuredly executed when autonomous driving is possible. In addition, regarding an autonomous driving transition area that is set before an autonomous-driving-vehicle-dedicated road, if an ETC toll gate is present within the autonomous-driving-vehicle-dedicated road and thus insertion of an ETC card is necessary as a condition of performing selection to start using autonomous driving in the autonomous driving transition area, entry into the autonomous driving transition area in a state where the ETC card has not yet been inserted can be prevented, whereby the driver of the autonomous driving vehicle can be prevented beforehand from becoming unable to select autonomous driving. In addition, it is possible to prevent beforehand the autonomous driving vehicle from, owing to a human error such as forgetting to insert an ETC card, entering the ETC toll gate while the ETC card has not yet been inserted or entering a toll gate for cash payment. In addition, only if the information that is about necessity of autonomous driving and that has been selected through the autonomous driving function selection device 80 indicates “necessary” and the output of the usability information from the on-vehicle control device 10 to the autonomous traveling control device 100 indicates “usable”, autonomous driving is executed by the autonomous traveling control device 100. Thus, the autonomous driving function selection device 80 does not receive any malicious intervention operation upon hacking or the like from outside the vehicle, and the driver cannot start autonomous driving in a state where the apparatus is in a state of being incapable of autonomous driving. Therefore, autonomous driving can be assuredly executed when autonomous driving is possible. In addition, the output of the usability status information to the information providing device 70 by the on-vehicle control device 10 and the output of the usability information to the autonomous traveling control device 100 by the on-vehicle control device 10, are performed at the time of start-up of the autonomous driving system 1 and at the predetermined cycle, whereby autonomous driving can be assuredly continued to be executed. In addition, the device status information includes information that is based on reception information wirelessly received by the on-vehicle wireless communication device 20. Thus, even if the received information is autonomous driving start inquiry information for making an inquiry as to whether or not to start autonomous driving regardless of presence/absence of an ETC toll gate, autonomous driving can be assuredly executed when autonomous driving is possible.

### Embodiment 2

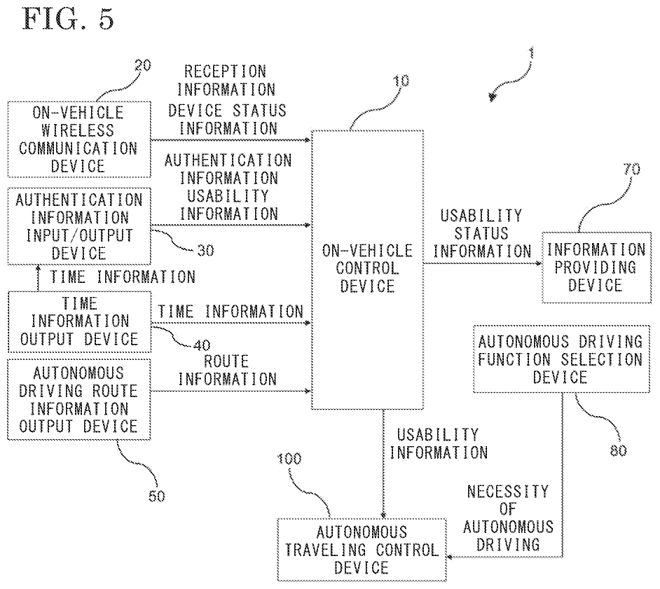

An autonomous driving system 1 according to embodiment 2 will be described. FIG. 5 is a diagram showing the entire configuration of the autonomous driving system 1. The autonomous driving system 1 according to embodiment 2 includes an autonomous driving route information output device 50 in addition to the components of the autonomous driving system 1 described in embodiment 1.

The autonomous driving route information output device 50 outputs, to the on-vehicle control device 10, autonomous driving traveling route information that includes information about a position and an attribute of a traveling lane on which autonomous driving is possible. Autonomous driving traveling route information is a list of autonomous driving maps indicating routes of traveling lanes on which autonomous driving is possible and autonomous driving traveling lane information according to which traveling by autonomous driving is performed. The autonomous driving traveling route information includes the positions of the traveling lanes and attributes of the traveling lanes (bus-dedicated lane, ETC toll gate entry road, climbing lane, converging road, diverging road, parking lot entry/exit gate entry road, and autonomous driving transition section). The autonomous driving traveling route information is created by the autonomous driving route information output device 50 but may be saved in the autonomous driving route information output device 50 in advance.

Although “usable” or “unusable” about the on-vehicle wireless communication device 20 and the authentication information input/output device 30 included in the apparatus is outputted to the information providing device 70 and the autonomous traveling control device 100 in embodiment 1, the configuration of the apparatus sometimes varies according to a traveling route for autonomous driving. For example, if the autonomous driving vehicle does not travel on any toll road (does not pass through any ETC toll gate), it is not necessary to, in step S107 shown in FIG. 2, set the autonomous driving possibility status information as “unusable” and output the autonomous driving possibility status information to the information providing device 70, and set the usability information as “unusable” and output the usability information to the autonomous traveling control device 100 in the case where an ETC card is unusable. In the present embodiment 2, the on-vehicle control device 10 determines, from the attributes of the traveling lanes having been inputted thereto, whether or not to use the on-vehicle wireless communication device 20 and the authentication information input/output device 30. If it is determined not to use the on-vehicle wireless communication device 20 and the authentication information input/output device 30, the on-vehicle control device 10 reports, to the autonomous traveling control device 100, that no outputs from the on-vehicle wireless communication device 20 and the authentication information input/output device 30 are necessary. Meanwhile, if it is determined to use the on-vehicle wireless communication device 20 and the authentication information input/output device 30, the same process as that in the above embodiment 1 is performed.

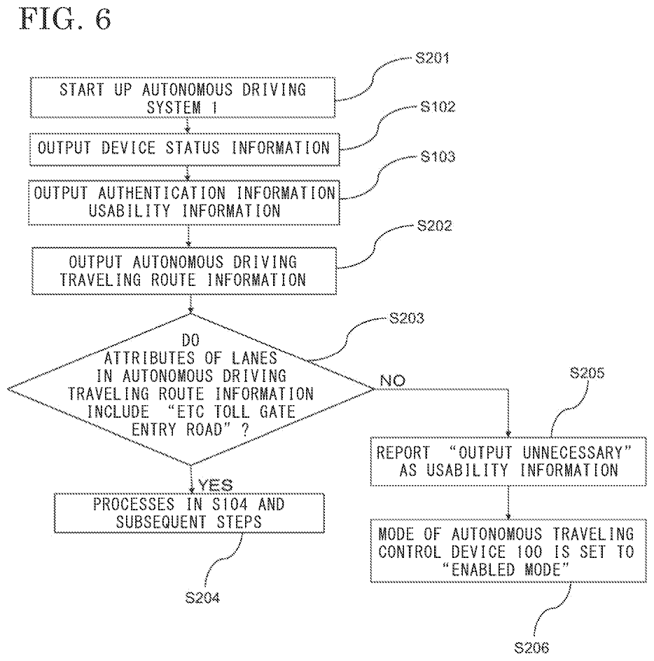

Next, processes that are performed at the time of start-up of the autonomous driving system 1 will be described. FIG. 6 is a flowchart showing processes that are performed at the time of start-up of the autonomous driving system 1 according to embodiment 2. First, the autonomous driving system 1 is started up (step S201). The processes in step S102 and step S103 are the same as those in FIG. 2, and thus descriptions thereof will be omitted.

The autonomous driving route information output device 50 outputs, to the on-vehicle control device 10, autonomous driving traveling route information that includes information about positions and attributes of traveling lanes on which autonomous driving is possible (step S202). The on-vehicle control device 10 checks whether or not the attributes of the traveling lanes in the autonomous driving traveling route information outputted from the autonomous driving route information output device 50 include “ETC toll gate entry road”, and determines whether or not to use the on-vehicle wireless communication device 20 and the authentication information input/output device 30 (step S203). If “ETC toll gate entry road” is included, the on-vehicle wireless communication device 20 and the authentication information input/output device 30 are used, and thus the procedure proceeds to processes in step S104 and the subsequent steps shown in FIG. 2 (step S204). If “ETC toll gate entry road” is not included, neither the on-vehicle wireless communication device 20 nor the authentication information input/output device 30 is used, and thus the procedure proceeds to step S205. Processes in step S104 and the subsequent steps are the same as those in FIG. 2, and thus descriptions thereof will be omitted.

The on-vehicle control device 10 reports, to the autonomous traveling control device 100, that no outputs from the on-vehicle wireless communication device 20 and the authentication information input/output device 30 are necessary as usability information about the on-vehicle wireless communication device 20 and the authentication information input/output device 30 (step S205). If the driver gives an instruction to execute autonomous driving through the autonomous driving function selection device 80, the autonomous traveling control device 100 performs determination as to possibility of execution of autonomous driving, and the mode of the autonomous traveling control device 100 is set to the “enabled mode” so that autonomous driving is executed (step S206).

As described above, the autonomous driving system 1 according to embodiment 2 includes the autonomous driving route information output device 50 which outputs, to the on-vehicle control device 10, the autonomous driving traveling route information that includes the information about the positions and the attributes of the traveling lanes on which autonomous driving is possible, and the on-vehicle control device 10 determines, from the attributes having been inputted thereto, whether or not to use the on-vehicle wireless communication device 20 and the authentication information input/output device 30. Thus, when the autonomous driving vehicle executes autonomous traveling on a route on which ETC is not used, the autonomous driving system 1 does not request the driver to insert an ETC card into the authentication information input/output device 30. Therefore, the driver can assuredly cause execution of autonomous driving without being bothered by an operation.

### Embodiment 3

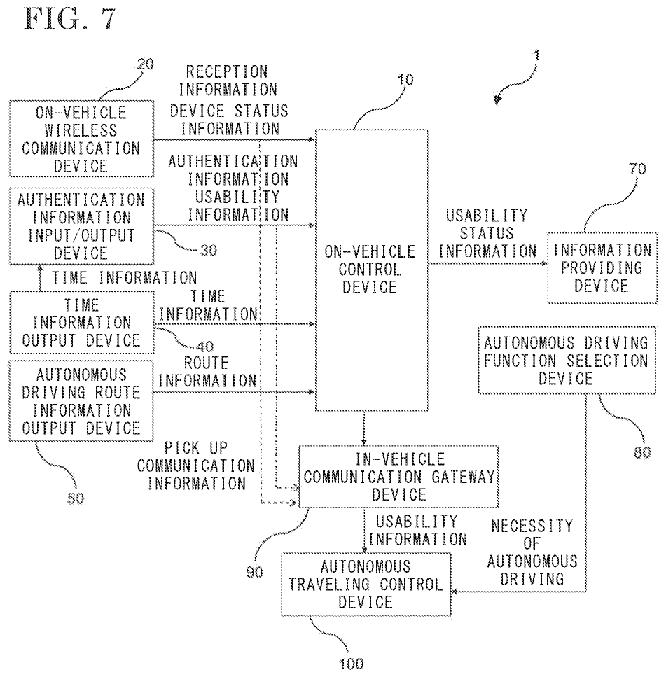

An autonomous driving system 1 according to embodiment 3 will be described. FIG. 7 is a diagram showing the entire configuration of the autonomous driving system 1. The autonomous driving system 1 according to embodiment 3 includes an in-vehicle communication gateway device 90 in addition to the components of the autonomous driving system 1 described in embodiment 2.

The in-vehicle communication gateway device 90 is provided between the on-vehicle control device 10 and the autonomous traveling control device 100 and relays the output from the on-vehicle control device 10 to the autonomous traveling control device 100. The in-vehicle communication gateway device 90 checks, on the basis of preset supervisory sequence information, whether an input from the on-vehicle control device 10 is correct or incorrect. If the input is correct, a relay of the output from the on-vehicle control device 10 to the autonomous traveling control device 100 is executed. Meanwhile, if the input is incorrect, cancellation of the input from the on-vehicle control device 10 is executed.

If the on-vehicle control device 10 connected to the on-vehicle wireless communication device 20 having a function to perform communication with the outside of the vehicle directly communicates an input/output with the autonomous traveling control device 100, there is a chance that, for example, a cyberattack by means of hacking or the like is inflicted from outside the vehicle through the on-vehicle control device 10 to the autonomous traveling control device 100. With the in-vehicle communication gateway device 90 being provided, the output from the on-vehicle control device 10 to the autonomous traveling control device 100 passes through the in-vehicle communication gateway device 90. The in-vehicle communication gateway device 90 checks, on the basis of the supervisory sequence information, whether or not the output from the on-vehicle control device 10 to the autonomous traveling control device 100 is performed after a predetermined process. Only if the result of the check is that the said output is performed after the predetermined process, the in-vehicle communication gateway device 90 relays the said output. Thus, malicious intervention via outside-of-vehicle communication to the autonomous traveling control device 100 is prevented.

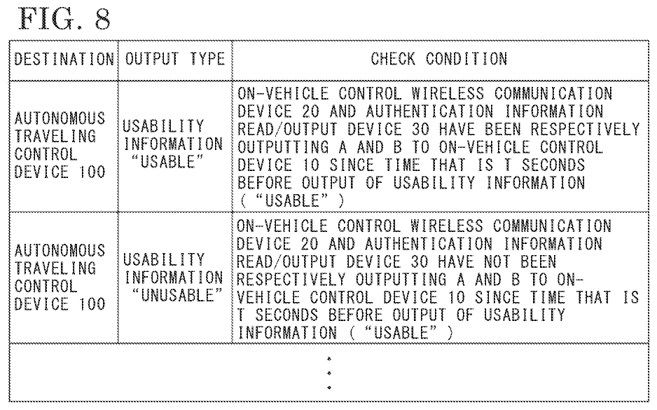

As shown in, for example, FIG. 7, the in-vehicle communication gateway device 90 picks up the outputs from the on-vehicle wireless communication device 20 and the authentication information input/output device 30, and the supervisory sequence information is a communication sequence for the on-vehicle wireless communication device 20 and the authentication information input/output device 30. FIG. 8 is a diagram showing an implementation example of the supervisory sequence information in the autonomous driving system 1 according to embodiment 3. The supervisory sequence information includes destination information, output type information, and a check condition, for each type of output, to check whether the output is correct or incorrect. For example, if the type of an output outputted from the on-vehicle control device 10 to the autonomous traveling control device 100 is usability information (“usable”), the check condition is defined as a condition that “the on-vehicle wireless communication device 20 and the authentication information input/output device 30 have been respectively outputting A and B to the on-vehicle control device 10 since a time that is T seconds before the output of the usability information (“usable”)”. It is noted that A and B represent outputs necessary for the on-vehicle control device 10 to make a specific output, and the content of each of outputs of A and B is not relevant to the present disclosure. Thus, the details of the content will not be described.

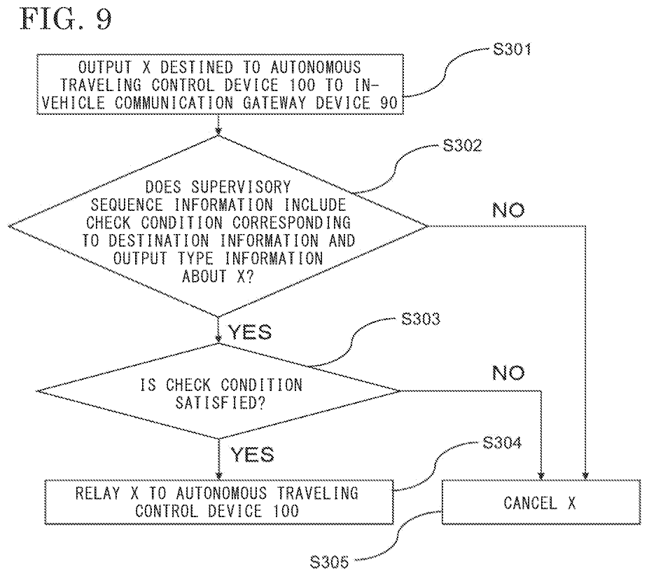

Next, processes that are performed by the in-vehicle communication gateway device 90 will be described. FIG. 9 is a flowchart showing processes that are performed by the in-vehicle communication gateway device 90 included in the autonomous driving system 1 according to embodiment 3. First, the on-vehicle control device 10 outputs, to the in-vehicle communication gateway device 90, X that is destined to the autonomous traveling control device 100 (step S301). At this time, destination information indicating a destination (autonomous traveling control device 100), output type information indicating the type of the output (output type: X), and output content information indicating content of the output, are inputted to the in-vehicle communication gateway device 90.

The in-vehicle communication gateway device 90 checks whether or not the supervisory sequence information includes destination information, output type information, and a check condition about X (step S302). If the destination information, the output type information, and the check condition are included, the procedure proceeds to step S303. Meanwhile, if the destination information, the output type information, and the check condition are not included, the procedure proceeds to step S305.

If the destination information, the output type information, and the check condition are included, a process of checking whether the output is correct or incorrect is performed according to the check condition (step S303). If the result of the check matches the condition so that the output is determined to be correct, the procedure proceeds to step S304. Meanwhile, if the result does not match the condition so that the output is determined to be incorrect, the procedure proceeds to step S305. In the case where the output is correct, the in-vehicle communication gateway device 90 executes a relay of X outputted to the autonomous traveling control device 100 (step S304). Meanwhile, in the case where the output is incorrect, the in-vehicle communication gateway device 90 executes cancellation of X (step S305). Cancellation of X is executed also if the destination information, the output type information, and the check condition are not present.

It is noted that, although the supervisory sequence information has been described above as the communication sequence for the on-vehicle wireless communication device 20 and the authentication information input/output device 30, the supervisory sequence information is not limited to the communication sequence and may include a communication sequence for another device such as the autonomous driving route information output device 50.

As described above, the autonomous driving system 1 according to embodiment 3 includes the in-vehicle communication gateway device 90, and the in-vehicle communication gateway device 90 checks, on the basis of the preset supervisory sequence information, whether the output from the on-vehicle control device 10 to the autonomous traveling control device 100 is correct or incorrect. Thus, even when a malicious hacker attempts to input usability information (“usable”) as an output to the autonomous traveling control device 100 at an intended timing, the in-vehicle communication gateway device 90 can cancel the output, and the driver can assuredly cause execution of autonomous driving. In addition, if the supervisory sequence information is the communication sequence for the on-vehicle wireless communication device 20 and the authentication information input/output device 30, it is possible to inhibit an attack in which a program of the on-vehicle control device 10 is rewritten via communication of the on-vehicle wireless communication device 20 by a malicious hacker or the like, and the driver can assuredly cause execution of autonomous driving.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the technical scope of the specification of the present disclosure. For example, at least one of the constituent parts may be modified, added, or eliminated. At least one of the constituent parts mentioned in at least one of the preferred embodiments may be selected and combined with the constituent parts mentioned in another preferred embodiment.

### DESCRIPTION OF THE REFERENCE CHARACTERS

1 autonomous driving system
10 on-vehicle control device
20 on-vehicle wireless communication device
30 authentication information input/output device
40 time information output device
50 autonomous driving route information output device
70 information providing device
80 autonomous driving function selection device
90 in-vehicle communication gateway device
100 autonomous traveling control device

1. An autonomous driving system comprising:
an autonomous driving function selection device through which selection as to necessity of autonomous driving is performed;
an on-vehicle wireless communication device which outputs device status information indicating an operational status of the on-vehicle wireless communication device itself;
an authentication information input/output device which outputs usability information about authentication information for use during driving;
an on-vehicle control device which outputs, on the basis of the outputs from the on-vehicle wireless communication device and the authentication information input/output device, usability status information about the on-vehicle wireless communication device and the authentication information input/output device and usability information about the on-vehicle wireless communication device and the authentication information input/output device;
an information providing device which physically reports, inside a vehicle, a status regarding usability on the basis of the usability status information; and
an autonomous traveling control device which performs determination as to possibility of execution of autonomous driving on the basis of the usability information and information that is about necessity of autonomous driving and that has been selected through the autonomous driving function selection device.

2. The autonomous driving system according to claim 1, wherein, only if the information that is about necessity of autonomous driving and that has been selected through the autonomous driving function selection device indicates “necessary” and the usability information indicates “usable”, the autonomous traveling control device determines that execution of autonomous driving is possible.

3. The autonomous driving system according to claim 1, wherein the output of the usability status information from the on-vehicle control device and the output of the usability information from the on-vehicle control device are performed at a time of start-up and at a predetermined cycle.

4. The autonomous driving system according to claim 1, further comprising
an autonomous driving route information output device which outputs, to the on-vehicle control device, autonomous driving traveling route information that includes information about a position and an attribute of a traveling lane on which autonomous driving is possible, wherein
the on-vehicle control device determines, from the attribute having been inputted thereto, whether or not to use the on-vehicle wireless communication device and the authentication information input/output device,
if it is determined not to use the on-vehicle wireless communication device and the authentication information input/output device, the on-vehicle control device reports, to the autonomous traveling control device, that no outputs from the on-vehicle wireless communication device and the authentication information input/output device are necessary, and
if it is determined to use the on-vehicle wireless communication device and the authentication information input/output device, the on-vehicle control device outputs, on the basis of the outputs from the on-vehicle wireless communication device and the authentication information input/output device, the usability status information about the on-vehicle wireless communication device and the authentication information input/output device and the usability information about the on-vehicle wireless communication device and the authentication information input/output device.

5. The autonomous driving system according to claim 1, wherein the device status information includes information that is based on reception information wirelessly received by the on-vehicle wireless communication device.

6. The autonomous driving system according to claim 1, further comprising
an in-vehicle communication gateway device which is provided between the on-vehicle control device and the autonomous traveling control device and which relays the output from the on-vehicle control device to the autonomous traveling control device, wherein
the in-vehicle communication gateway device checks, on the basis of preset supervisory sequence information, whether an input from the on-vehicle control device is correct or incorrect,
if the input from the on-vehicle control device is correct, the in-vehicle communication gateway device executes a relay of the input from the on-vehicle control device, and
if the input from the on-vehicle control device is incorrect, the in-vehicle communication gateway device executes cancellation of the input from the on-vehicle control device.

7. The autonomous driving system according to claim 6, wherein
the in-vehicle communication gateway device picks up the outputs from the on-vehicle wireless communication device and the authentication information input/output device, and
the supervisory sequence information is a communication sequence for the on-vehicle wireless communication device and the authentication information input/output device.
